(19) United States
(12) Patent Application Publication
(10) Pub. No.: US 2010/0072440 A1
(43) Pub. Date: Mar. 25, 2010

(54) APPARATUS AND METHOD FOR DRAWING A CABLE THROUGH AN OPENING

(76) Inventor: Sharon Wright, Scunthorpe Lincolnshire (GB)

Correspondence Address: Workman Nydegger;1000 Eagle Gate Tower, 60 East South Temple, Salt Lake City, UT, 84111, US

(21) Appl. No.: 12/444,445

(22) PCT Filed: Oct. 5, 2007
(86) PCT No.: PCT/GB2007/050616

§ 371 Date: Nov. 9, 2009

(30) Foreign Application Priority Data
Oct. 6, 2006 (GB) 0619766.9
Mar. 12, 2007 (GB) 0704716.0

(51) Int. Cl. H02G 1/08

(52) U.S. Cl. 254/134.3 R

(57) ABSTRACT

A device (10) for installing an elongate conducting member, e.g. an electrical cable, through a partition such as a wall, the device comprising an end cap (12) adapted to receive an elongate conducting member, a retrieving portion (14), coupling means to couple the end cap with the retrieving portion (14); and attachment means (42) to attach said elongate conducting member to the end cap (12), wherein the attachment means (42) is integral with the end cap (12) and engages with the outer surface of the elongate conducting member. A method of installing the elongate conducting member through a partition is also provided. The device (10) provides means for attaching an elongate member to the end cap (12) without damaging the member and also convenient means for retrieving the end cap (12) to thereby pull the elongate member to complete the installation.

The present invention generally relates to an apparatus and method for the installation of an elongate member, such as a cable, wire or tube. More specifically, the invention relates to a device, kit and method for feeding cable, wire or tubing from an entry opening to an exit opening, e.g. between holes drilled through a partition such as a cavity wall in a building or a bulkhead in an automotive application.

Electrical fixtures or appliances in domestic or commercial buildings are often situated some distance from a suitable electrical power source and hence require the running of cable or wire through the building to connect the fixtures to the power source. In a similar vein, telecommunication or computer equipment often requires wires or cables to connect it to the relevant communication network. This often involves running cable or wire inside or through partitions including walls, flooring and ceilings, particularly those including a cavity. Additionally, the installation of flexible or relatively rigid tubing is also sometimes required to protect the cable or wire when installed.

Additionally, during automotive manufacturing, electrical wiring or tubing is fed, in a similar way, from one section of a vehicle to another section, e.g. from the engine compartment to the cabin. This often requires feeding the wiring or tubing through a partition, e.g. a bulkhead including a cavity, such as the dashboard of a vehicle.

It is highly inconvenient, and often impossible, to thread a cable or wire through a cavity, i.e. from an entry hole to an exit hole. This is because once the cable or wire is passed into the entry hole, it is no longer possible to guide the leading end of the cable or wire and it may be impossible to line it up with the exit hole. Even when this can be achieved, the process of threading such cables takes a significant amount of time.

In an attempt to overcome this, when installing a wire, cable or tube in a cavity wall, for example, an installer drills holes or cuts small access openings in the partition and attaches the cable or wire to one end of a line or ‘snake’. He then feeds the other end of the ‘snake’ into one of the openings before attempting to retrieve the ‘snake’, and attached cable or wire, through the other opening. The ‘snake’ is generally adapted to be easier to thread through the cavity than the cable or wire, thus easing the process. In the electrical trade this procedure is commonly referred to as ‘fishing’.

A significant problem associated with ‘fishing’ is the retrieval of the ‘snake’ through the exit hole. Attempts which have been proposed to overcome this problem are disclosed in U.S. Pat. No. 3,971,543. This document discloses a device having a weighted, magnetically-attractable element connected to the cable or wire via a length of chain to which the cable or wire is tied. The magnetically-attractable element is dropped through an upper hole, swung on the chain and located at a lower level by a magnetic rod. When successful, the magnetically-attractable element is pulled through a lower hole with the attached cable or wire.

This device, however, only works where two holes are aligned substantially vertically. A further disadvantage of this device lies in its use being limited to large holes or openings relative to the cable itself. The knot which is required to tie the cable or wire to the chain will be larger than the cable itself, particularly when the cable is thick. In addition, tying a knot in a relatively rigid or thick cable or wire may be impossible.

In an attempt to solve some of the disadvantages associated with knotting an electrical wire to the device, U.S. Pat. No. 3,078,073 discloses a housing, to receive an end of the core of a wire, including a grub screw which tightens on to the core to secure the wire to the housing. Although this device solves the problem of knotting a wire to the device, it has its own disadvantages including the risk of damage to the wire core itself. Additionally, this device may not be suitable to receive and secure cables having more than one core, e.g. multi-core cable, as the grub screw must be relatively large to tighten down across the number of cores. Additionally, a tension on the cable may cause the core to slip from the grub screw and out of the housing resulting in the cable being lost within the partition in which it is being installed. In addition, this device is relatively complex and expensive to manufacture, requiring several parts, the formation of a screw thread through the housing and installation of a grub screw. It would also be extremely easy for the grub screw to become lost, thus rendering the device useless.

Improved cable or wire installing devices are required. Desirably, such devices would be suitably adapted to:
install flexible or rigid elongate members from an entry opening across a cavity to an exit opening;
allow convenient attachment to elongate members of a variety of widths;
cause no significant damage to the core(s) of cables or wires;
allow a cable or wire to be secured to the device without knotting or bending; and/or
be simple and inexpensive to manufacture.

According to a first aspect, the present invention provides a device for installing an elongate conducting member, the device comprising:
an end cap adapted to receive an elongate conducting member;
a retrieving portion;
coupling means to couple the end cap with the retrieving portion; and
attachment means to attach said elongate conducting member to the end cap, wherein the attachment means is integral with the end cap and engages with the outer surface of the elongate conducting member.

The term elongate conducting member is intended to relate to any generally long and thin member which conducts something along its length, e.g. electricity, light or fluid. Thus the term includes electrical cables and wires, fibre optic cables and wires, pipes and tubes.

Preferably, said end cap has a recess to receive an end of the elongate conducting member. The attachment means may suitably be provided in or around said recess.

Advantageously, where the attachment means engages with the outer surface of the elongate conducting member, this prevents the potentially fragile internals from being damaged. Damage to the core during installation could, especially if not detected at the time, result in major work being carried out to identify the fault and remove and replace or repair the damaged member. This can cause great expense, inconvenience and delay the completion of installation.

Preferably, the attachment means is adapted to engage with the outer surface of the elongate conducting member at a plurality of points, or across a significant area of the outer surface.

Preferably, the attachment means is adapted to resist a tension on the elongate conducting member to retain the end of the member. This prevents the member coming away from the end cap during installation.

The attachment means may, in one preferred embodiment, comprise one or more projections within a recess provided in the end cap.

Suitably, the one or more projections may be arranged in a circular or helical arrangement within the recess. This allows the attachment means to contact and thus engage with the elongate conducting member around its outer surface.

In a particularly preferred embodiment, the attachment means comprises a helical thread within the recess of the end cap. The thread may be continuous, or may be discontinuous, i.e. the thread may be interspersed with gaps.

In another embodiment, the end cap may comprise one or more barb-like projections which secure to engage the elongate conducting member. When tension is applied to the elongate conducting member, the barbs tend to bite into the outer surface of the member.

A helical thread has the advantage that the end cap can be attached to the elongate conducting member using a twisting motion, allowing for a secure attachment with minimal effort. It also allows for the simple removal of the end cap following installation of the elongate conducting member.

Where barb-like projections are used, it may be necessary to cut the end cap from the elongate conducting member, though it may be possible to remove the member by, for example, twisting it to disengage or break the projections.

Preferably, the screw attachment means has dimensions adequate to secure the elongate conducting member to the end cap without causing significant damage to the member.

Conveniently, the attachment means may be formed from the same material as the end cap. Projections, such as a thread or barbs, may be conveniently formed as part of a moulding or similar process by which the cap is formed. Alternatively, the projections could be formed in a subsequent machining step.

Suitably, the attachment means is formed from a relatively rigid material which is capable of biting into a comparatively soft material forming the insulating sheath of a cable or wire. Suitable plastics materials are well known in the art. It may be desirable that the attachment means is capable of deforming to grip a relatively solid material, such as a metal pipe.

Preferably, where the attachment means is a screw thread, the screw thread has a minimum thread pitch of 1 mm. It has been found that a thread pitch of from 2 to 5 mm, especially around 3 mm, is particularly suitable. Preferably, the screw thread has a minimum thread depth of 0.1 mm. It has been found that a thread depth of from 0.1 to 0.5 mm, especially around 0.2 mm, is particularly suitable. Preferably, the screw thread has a minimum thread angle of 1 degree. It has been found that a thread angle of from 9 to 12 degrees is particularly suitable.

Preferably, the attachment means is adapted to conveniently release the elongate conducting member to allow the end cap to be used more than once. However, it may be equally convenient to provide a plurality of disposable end caps such that re-use is not required. This is achievable due to the simple manufacture method of the end cap according to the present invention.

Preferably, the recess of the end cap is tapered, from being wider at the entrance of the recess, narrowing along its length. Such a taper allows a single end cap to be fitted to elongate conducting members of differing thicknesses. The degree of tapering will depend on the particular application of the end cap, but an angle of from 1 to 15 degrees of taper, relative to the centre axis of the recess may be suitable. The taper also has the advantage that as the end cap is pressed or screwed further onto the elongate conducting member a firmer attachment is achieved. However, with firmer attachment comes the danger of potential damage to the end of the elongate conducting member. Where this is a concern, the user can insert the member into the end cap such that a desired security of attachment is achieved, but not to such an extent that the member is damaged. Where damage is not a concern, the end cap can be pressed or screwed on firmly, thus achieving a very strong attachment.

The end cap may suitably comprise gripping means on an outer surface to provide grip to a user when the end cap is being attached to or removed from the elongate conducting member. Where the attachment means comprises a screw thread, the gripping means conveniently aids the twisting motion required when screwing the end cap on to the elongate member. Suitable gripping means may include one or more raised or depressed portions on an outer surface of the end cap. Alternatively, an engraved pattern may be formed in the outer surface of the end cap by known manufacturing techniques, e.g. injection moulding or knurling.

Preferably, the end cap comprises a first part of the coupling means.

Preferably, the retrieving portion comprises a second part of the coupling means.

The first and second parts of the coupling means may comprise any suitable material or medium which will couple when brought into proximity or contact with each other and, importantly, remain coupled when subjected to a tension. Suitable examples for one, other or both of the first and second parts, as appropriate, include magnets, Velcro or adhesive.

Suitably, one, other or both of the first or second parts of the coupling means comprises a magnet. Advantageously, the use of a magnet allows the end cap to be attracted to the retrieving portion, or vice versa, without actually contacting each other. Additionally, magnets are re-usable, and are relatively resistant to deleterious effects of dirt, liquid or other contaminants.

The coupling means may comprise two magnets arranged such that, when brought together, opposite magnetic poles are engaged.

Alternatively, one of the first or second parts of the coupling means may comprise a magnet and the other part a material which is attracted to the magnet, e.g. iron, steel or zinc.

In a particularly preferred embodiment, the end cap comprises a generally cylindrical body, one end of the cylinder comprising a recess for receiving the elongate conducting member, the other end of the cylinder having the first part of the coupling means. The dimensions of the end cap can, of course, be varied depending on the size or shape of the elongate conducting member of interest. For example, the cap may have a length of from 5 mm to 150 mm, preferably from 10 mm to 50 mm, and an outer diameter of from 3 mm to 30 mm, preferably from 5 mm to 15 mm. A particularly suitable length and outer diameter is 30 mm and 8 mm respectively. The tapered recess to receive the elongate member will suitably have an entrance diameter which is slightly less than the outer diameter of the end cap. The recess may have an entrance diameter of from 2 mm to 29 mm and an opposite base end having a diameter of from 2 mm to 5 mm. A recess having such dimensions is therefore suitable for receiving an array of elongate members having different outer diameters, including conventional electrical flux cable.

The retrieving portion suitably comprises an elongate member having a handle at one end and the second part of the coupling means disposed at or near the other end. The overriding principle of the retrieving portion is that it can be used to retrieve the end cap from within a cavity, e.g. a wall cavity. Thus it may be that a substantially rigid retrieving portion is desirable, such that the retrieving portion may be accurately extended across a cavity. A resilient retrieving portion may be preferred in other situations where, for example, a bend or obstruction must be negotiated.

It is generally preferred that, the elongate member is substantially rigid.

The elongate member may have a cruciform cross-section. However, any suitable cross section providing adequate stiffness to allow the retrieving portion to span a cavity without significant bending may be used. Suitable examples include circular, square, rectangular or I-section.

The handle may be substantially flat and optionally have a peripheral rim. A label may be adhered to the handle portion or a mark may moulded into the handle portion showing the name of the device, brand or a company logo, for example.

Suitably, the handle portion may comprise a hole. This hole may be used to store the device by hanging from a wall or secure the retrieving portion to the wrist of a user during operation via a loop or band.

Preferably, the device is manufactured substantially from a plastics material.

According to a further aspect, the present invention provides a method of installing an elongate conducting member using a device as described above, the method comprising the steps of:
attaching an end of the elongate conducting member to an end cap;
coupling the end cap to a retrieving portion via coupling means; and
pulling the retrieving portion, end cap and elongate conducting member.

Suitably, the method is performed through a cavity wall or in an automotive wiring application.

Preferred embodiments of the end cap and retrieving member are set out above and methods of their use will be apparent to the person skilled in the art.

The present invention will now be described, by way of example only, with reference to the accompanying drawings, in which:

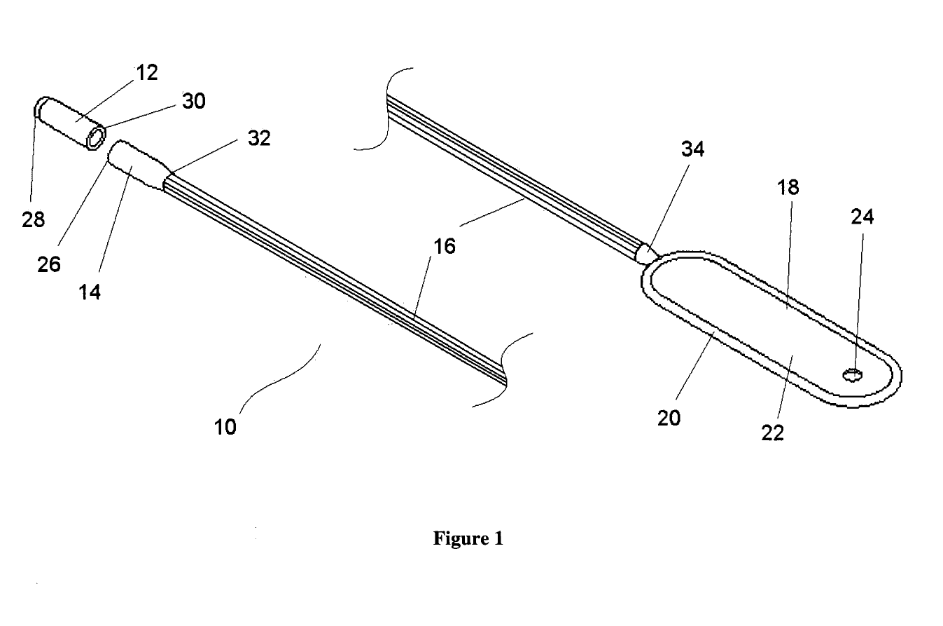

FIG. 1 is a schematic illustration of one embodiment of the device;

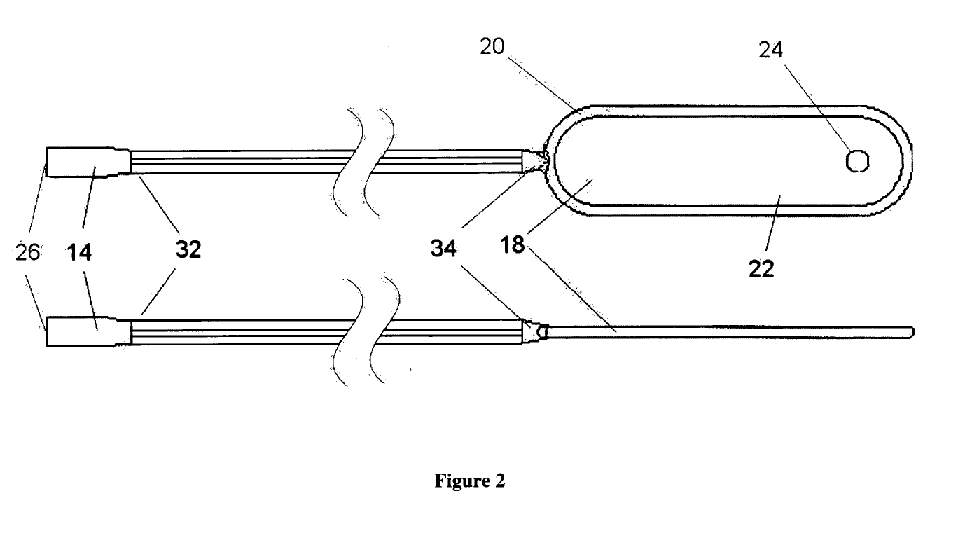

FIG. 2 shows plan and side views of one embodiment of the retrieving portion in accordance with the present invention;

FIG. 3 is a front view of the end cap facing towards the open end;

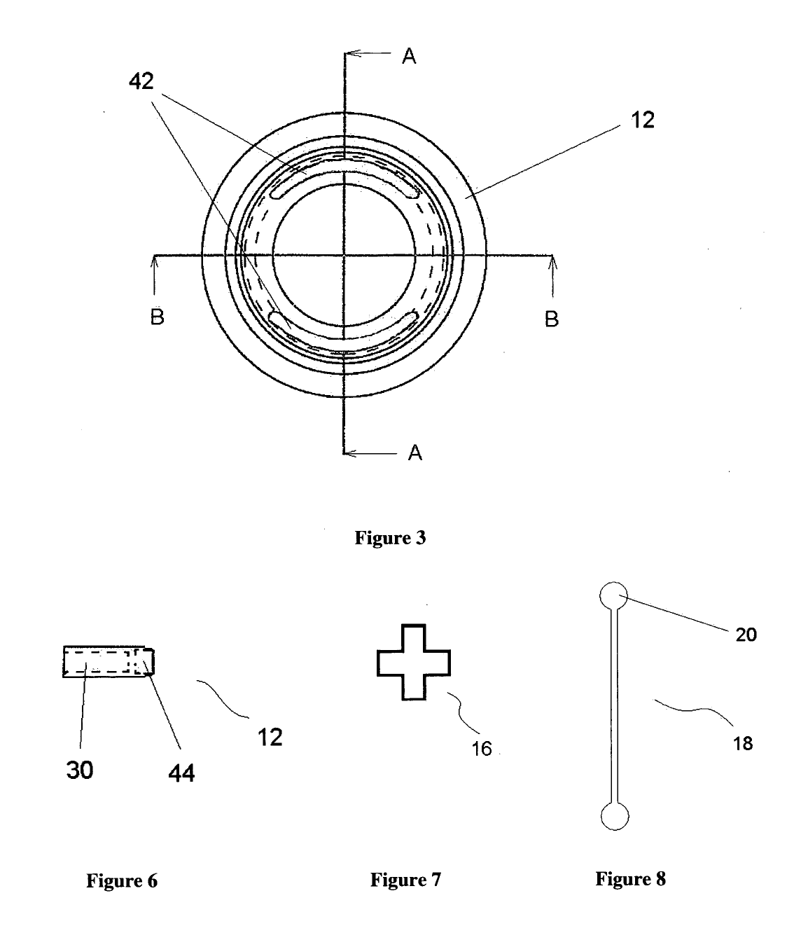

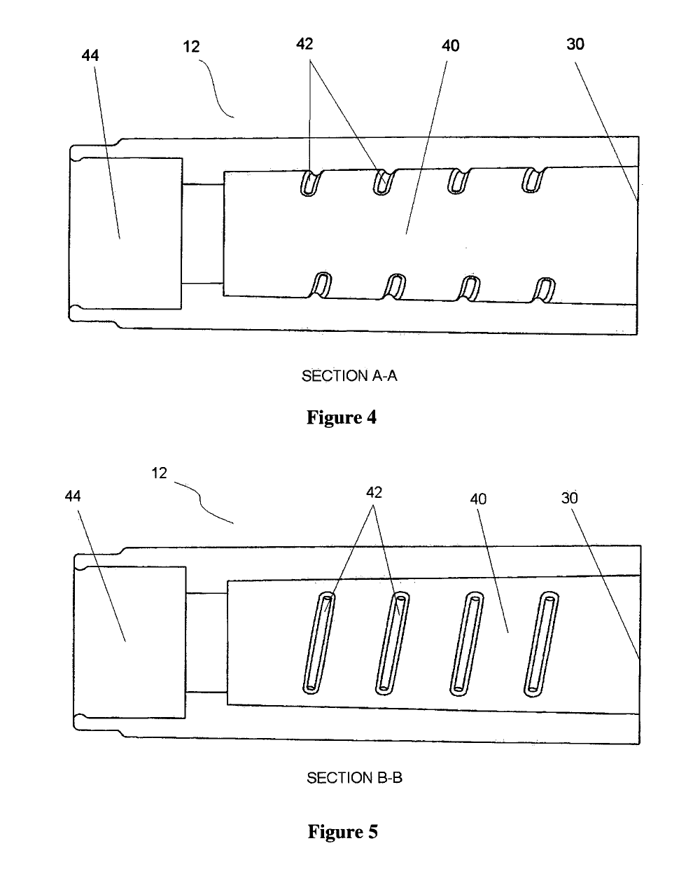

FIG. 4 is a sectional view along section line A-A in FIG. 3;

FIG. 5 is a sectional view along section line B-B in FIG. 3;

FIG. 6 is a sectional view through another embodiment of the end cap;

FIG. 7 is a sectional view through the elongate member of the retrieving portion;

FIG. 8 is a sectional view through the handle of the retrieving portion; and

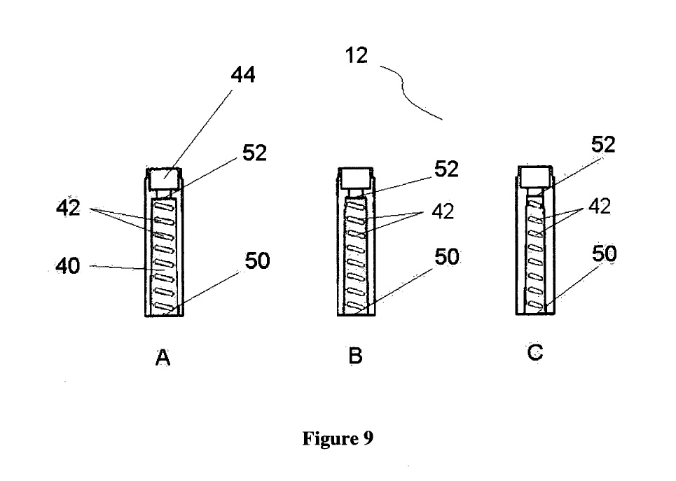

FIG. 9 shows a variety of end caps having different recess dimensions.

As shown in FIGS. 1 to 9, a device (10) for installing an elongate conducting member such as a cable, wire or tube across a partition e.g. a cavity wall or vehicle bulkhead, comprises a cylindrical end cap (12), a retrieving portion (14) and coupling means located on both the end cap (12) and retrieving portion (14). The coupling means is adapted to couple the end cap (12) with the retrieving portion (14).

The coupling means suitably comprises a first and a second part, the first part on the end cap (12), the second part on the retrieving portion (14). Suitably, one or other of the first or second parts is a magnet, the other part being a magnetically-attractive composition or second magnet. It will be understood, however, that the coupling means may be any suitable means for coupling the end cap (12) with the retrieving portion (14). Suitable examples include two magnets having opposite poles (as mentioned above), Velcro or adhesive. Use of a magnetic coupling means is preferred.

The end cap (12) is adapted to attach to the end of an elongate conducting member (not shown), e.g. an electrical cable.

The end cap (12) has a tapered recess (40), which tapers inwardly from its open end (30). A screw thread (42) is provided on the inner surface of the recess (40). The cable (not shown) is screwed into the recess (40) where it engages with the screw thread (42) from the open end (30) and secured within the end cap (12) by the screw thread (42) engaging with the outer material of the cable, e.g. the outer flex of the cable. Engagement with the outer flex prevents the inner core of the cable from being damaged during installation. The screw thread (42) is suitably provided by moulding the thread into the surface of the recess (40).

The dimensions of the screw thread (42) are adequate to secure the cable to the end cap (12) without causing significant damage to the cable. The screw thread (42) is suitably tapered to allow a variety of cables with different diameters to be attached to the end cap (12). Additionally, the tapering allows a very secure fit to be achieved. The screw thread (42) may run continuously around the inside surface of the hollow portion (40), e.g. have a thread span of 360 degrees, or may be discontinuous e.g. provided in sections. It has been found that a thread span of around 90 degrees is particularly suitable. This provides adequate security to ensure the cable remains attached to the end cap (12) during installation, without causing significant damage to the cable. It has been found that a thread pitch of 3 mm and a thread angle of around 10 degrees are particularly suitable.

A first magnet (44) is disposed at or near a first coupling end (28) of the end cap (12), distal to the open end (30) where the cable is received. The first magnet (44) may be attached to the end of the end cap (12) (e.g. with adhesive) or be moulded within the end of the end cap (12).

A second magnet (not shown), is disposed at or near a coupling end (26) of a retrieving means (14). The first (44) and second magnets are adapted to be attracted to each another, i.e. arranged such that opposite poles are brought together.

Alternatively, one of the magnets may be replaced by a magnetically attractive composition, e.g. iron, steel or zinc.

The retrieving means (14) includes an elongate member (16) having a first end (32) at which the second magnet (not shown) is disposed. A handle portion (18) is provided at a second end (34) of the elongate member (16) to aid the user during use of the device (10).

As shown in FIGS. 1, 2 and 8, the handle portion (18) is substantially flat with a rim (20) running around its periphery. A label or mark (22) may be adhered, stamped or moulded on to or into the handle portion (18) to show a device name, brand or company logo, for example.

The elongate member (16) has a suitable cross section and is a suitable material to have adequate stiffness. As shown in FIG. 7, the elongate member (16) may have a cruciform cross-section. However, any suitable cross section providing adequate stiffness to allow the retrieving portion (14) to span a cavity without significant bending may be used. Suitable examples include circular, square, rectangular or I-section.

A particularly suitable length of the retrieving means (14) is 340 mm, including a handle portion (18) of around 105 mm long and 30 mm wide.

Where a crucifix cross section is chosen for the elongate member (16), a suitable width is around 6 mm and a suitable thickness is 2 mm. Of course, any other suitable dimensions may be used.

The device may be provided with a plurality of end caps (12) and a retrieving portion (14), each individual end cap (12) being adapted to receive a different diameter, or range of diameters, of elongate conducting member. A plurality of different end caps is shown in FIG. 9. The end caps (A, B and C) may have suitable lengths of around 30 mm and outer diameters of around 8 mm. To receive elongate conducting members of different outer diameter, the end caps (A, B and C) have different recess dimensions (recess entrance diameter (50) and recess base diameter (52)). Suitable recess dimensions (50, 52) for end cap A are 6 mm and 5.1 mm respectively. Suitable dimensions (50, 52) for end cap B are 5.2 mm and 4.3 mm respectively. Suitable dimensions (50, 52) for end cap C are 4.4 mm and 3.5 mm respectively. Of course, the number of different end caps is not limited and the dimensions may be varied.

To install an elongate member, such as a cable or wire, across a partition including a cavity, the installer may perform the following steps:
drill through the partition to form an entrance opening in one side of the partition and an exit opening in the opposing side of the partition;
attach an end of the cable, or the like, into the end cap (12) by screwing the end into the screw thread (42);
place the first coupling end (28) of the end cap (12) into the entrance opening;
place the second coupling end (26) of the retrieving portion (14) into the exit opening;
feed the retrieving portion (14) across the partition to snare the end cap (12) via the coupling means (magnets);
pull the retrieving portion (14), end cap (12) and attached cable through the exit opening; and
install the cable accordingly.

Modifications to the described embodiment may be made without departing from the scope of the invention.

1.-17. (canceled)

18. A device for installing an elongate conducting member, the device comprising:
an end cap adapted to receive an elongate conducting member;
a retrieving portion;
coupling means to couple the end cap with the retrieving portion; and
attachment means to attach said elongate conducting member to the end cap,
wherein the attachment means is integral with the end cap and engages with the outer surface of the elongate conducting member.

19. A device according to claim 18, wherein the end cap comprises a recess to receive an end of the elongate conducting member.

20. A device according to claim 19, wherein the attachment means is disposed in or around said recess.

21. A device according to claim 21, wherein the attachment means comprises one or more projections within the recess.

22. A device according to claim 21, wherein the attachment means comprises a screw thread.

23. A device according to claim 22, wherein the screw thread has a thread pitch of from 1 mm to 5 mm.

24. A device according to claim 22, wherein the screw thread has a thread depth of from 0.1 mm to 0.5 mm.

25. A device according to claim 22, wherein the screw thread has a thread angle of from 1 degree to 12 degrees.

26. A device according to claim 18, wherein the recess is tapered, from being wider at the entrance of the recess, narrowing along its length.

27. A device according to claim 26, wherein the recess has a taper angle of from 1 to 15 degrees, relative to the centre axis of the recess.

28. A device according to claim 18, wherein the end cap comprises a first part of the coupling means.

29. A device according to claim 18, wherein the retrieving portion comprises a second part of the coupling means.

30. A device according to claim 28, wherein the retrieving portion comprises a second part of the coupling means, one or both of the first or second parts comprising a magnet.

31. A device according to claim 30, wherein the retrieving portion comprises an elongate member having a handle at one end and the second part of the coupling means disposed at or near the other end.

32. A device according to claim 31, wherein the elongate member has a cruciform cross-section.

33. A device according to claim 32, wherein the device is manufactured substantially from a plastics material.

34. A method of installing an elongate conducting member using a device as claimed in claim 1, the method comprising the steps of:
attaching an end of an elongate conducting member to the end cap;
coupling the end cap to the retrieving portion via the coupling means; and
pulling the retrieving portion, end cap and elongate conducting member.
